(19) United States
(12) Patent Application Publication
(10) Pub. No.: US 2025/0243889 A1
(43) Pub. Date: Jul. 31, 2025

(54) FASTENING SYSTEMS FOR SURFACE COVERINGS

(71) Applicant: Toyota Canada Inc., Toronto (CA)

(72) Inventors: Cheryl Hohl, Mundelein, IL (US); Michael Vogler, Deerfield, IL (US); Ali Nouroozi, Toronto (CA); Zsolt Bancila, Toronto (CA); Milija Milinkovic, Toronto (CA)

(73) Assignee: Toyota Canada Inc., Toronto (CA)

(21) Appl. No.: 19/029,943

(22) Filed: Jan. 17, 2025

Related U.S. Application Data
(60) Provisional application No. 63/626,245, filed on Jan. 29, 2024.

(51) Int. Cl. F16B 21/07; B60N 3/04

(52) U.S. Cl. CPC F16B 21/073; B60N 3/046

(57) ABSTRACT

A fastening system for fastening a first portion of a surface covering to a second portion of the surface covering. The fastening system includes an insertion portion including a base portion and a cap portion protruding from the base portion. The base portion is configured to be disposed within a first fastener cavity of the first portion of the surface covering. The fastening system includes a receiving portion including a flange portion and a collar portion forming a receiving orifice. The flange portion is configured to be disposed within a second fastener cavity of the second portion of the surface covering. The cap portion of the insertion portion is configured to be removably disposed within the receiving orifice of the receiving portion so as to removal fasten the insertion portion to the receiving portion.

### CROSS-REFERENCE TO RELATED APPLICATIONS

This application claims priority to U.S. Provisional Application No. 63/626,245, filed Jan. 29, 2024, the entire disclosure of which is incorporated by reference herein.

### TECHNICAL FIELD

The present disclosure relates generally to the field of surface coverings, more specifically, floor coverings for vehicles.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Floor mats or other protective coverings may be used to protect various types of surface, including interior surfaces in cars, trucks, other vehicles, homes, workshops, buildings, etc. Such floor mats or protective coverings may be removed for replacement, cleaning, etc. Traditionally, multiple smaller floor mats may be used to cover a relatively large area of the surface (e.g., vehicle floor), but may fail to cover portions of the surface or non-uniform surface contours. But larger mats that cover large areas of floor may traditionally be difficult to remove or to clean due to their potentially unwieldly proportions.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a fastening system. The fastening system may include an insertion portion including a base portion configured to be coupled to a first portion of a surface covering, a stem portion protruding axially from the base portion, and a cap portion protruding radially outward from the stem portion opposite the base portion. The fastening system may also include a receiving portion including a collar portion forming a receiving orifice axially through the receiving portion, and a flange portion extending radially outward from the collar portion and configured to be coupled to a second portion of the surface covering. The cap portion of the insertion portion may be configured to be received through the receiving orifice of the receiving portion such that the stem portion is disposed within the receiving orifice, thereby fastening the insertion portion to the receiving portion and removably connecting the first portion of the surface covering to the second portion of the surface covering.

In another embodiment, the disclosure describes a fastening system for fastening a first portion of a surface covering to a second portion of the surface covering. The fastening system may include an insertion portion including a base portion and a cap portion protruding from the base portion. The base portion may be configured to be disposed within a first fastener cavity of the first portion of the surface covering. The fastening system may include a receiving portion including a flange portion and a collar portion forming a receiving orifice axially through the receiving portion. The flange portion may be configured to be disposed within a second fastener cavity of the second portion of the surface covering. The cap portion of the insertion portion may be configured to be removably received through the receiving orifice of the receiving portion so as to removal fasten the insertion portion to the receiving portion.

In another embodiment, the disclosure describes a surface covering that may include a first portion including a first fastener housing and a second portion including a second fastener housing. The surface covering may include an insertion portion including a base portion and a cap portion protruding from the base portion. The base portion may be disposed within the first fastener housing of the first portion. The surface covering may include a receiving portion including a flange portion and a collar portion forming a receiving orifice. The flange portion may be disposed within the second fastener housing of the second portion. The cap portion of the insertion portion may be configured to be removably received through the receiving orifice of the receiving portion so as to removal fasten the first portion to the second portion.

### BRIEF DESCRIPTION OF THE DRAWINGS

Non-limiting and non-exhaustive embodiments are described in reference to the following drawings. The components in the figures are not necessarily to scale, emphasis instead being placed upon illustrating the principles of the disclosure. In the drawings, like reference numerals refer to like parts through all the various figures unless otherwise specified.

For a better understanding of the present disclosure, a reference will be made to the following detailed description, which is to be read in association with the accompanying drawings, wherein:

FIG. 1A shows an embodiment of a fastening system in accordance with the disclosure;

FIG. 1B shows a zoomed-in view of the fastening system of FIG. 1A;

FIG. 2 shows a cross sectional view of the fastening system of FIG. 1A;

FIG. 3 shows another embodiment of a fastening system in accordance with the disclosure;

FIG. 4A shows a top perspective view of an embodiment of an insert portion of the fastening system of FIG. 3;

FIG. 4B shows a bottom perspective view of the insert portion of FIG. 4A;

FIG. 4C shows a side perspective view of the insert portion of FIG. 4A;

FIG. 5 shows the insert portion of FIG. 4 disposed in a first portion of a surface covering in accordance with the disclosure;

FIG. 6 shows a receiving portion of the fastening system of FIG. 3;

FIG. 7 shows a cross-sectional view of the fastening system of FIG. 3;

FIG. 8 shows another embodiment of a fastening system in accordance with the disclosure;

FIG. 9A shows a top perspective view of an embodiment of a receiving portion of the fastening system of FIG. 8;

FIG. 9B shows a bottom perspective view of the receiving portion of FIG. 9A; and

FIG. 10 shows a cross-sectional view of the fastening system of FIG. 8.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. This disclosure may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and includes plural references. The meaning of “in” includes “in” and “on.”

The disclosure describes, in some embodiments, a fastening system and method for fastening floor mats or other surface coverings. In some embodiments, the fastening system may be used to selectively connect multiple floor coverings, such as vehicle floor mats. However, those skilled in the art will recognize that the disclosed fastening system may be used an multitudes of other, non-vehicle contexts within the meaning of the disclosure. In some embodiments, the fastening system may also be used to selectively connect other surface coverings, such as carpets, rugs, mats, tarpaulins, etc. In general, some embodiments of the fastening system may include molded components, such as one or more receiving inserts and insertion posts, that may work with one another to fasten one or more portions of the surface covering to one another. In some embodiments, portions of the surface coverings themselves may be molded to include receiving portions or insertion portions that may fasten one or more portions of the surface coverings.

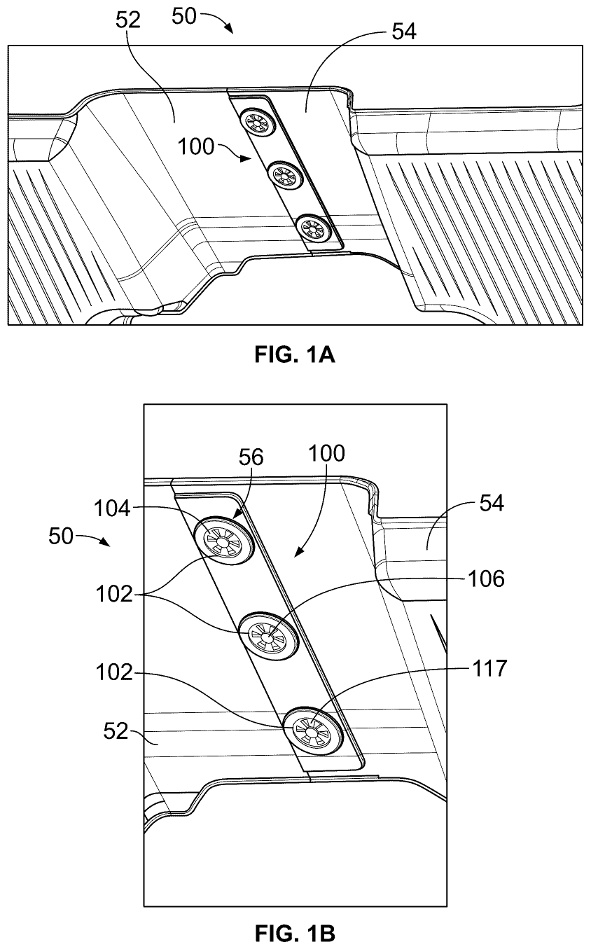

FIGS. 1A and 1B show an embodiment of a fastening system 100 that may be implemented to fasten two or more portions of a surface covering 50, such as a floor mat for a vehicle. The surface covering 50 may include a first portion 52 and a second portion 54 that may be fastened to one another using the fastening system 100. In some embodiments, the first and second portions 52, 54 of the surface covering 50 may include respective overlapping portions through which the fastening system 100 may be disposed to hold the first and second portions together in a selectively removable fashion.

FIG. 1B shows another view of the fastening system 100. In some embodiments, the fastening system 100 may include one or more fastener pairs 102 that may each include a receiving portion 104 and an insertion portion 106. In some embodiments, the insertion portion 106 may be connected to the first portion 52 of the surface covering 50, and the receiving portion 104 may be connected to the second portion 54 of the surface covering 50. It will be appreciated that, in some embodiments, the insertion portion 106 may be connected to the second portion 54 of the surface covering 50, and the receiving portion 104 may be connected to the first portion 54. It is additionally contemplated that, in some embodiments, each of the receiving portion 104 and/or the insertion portion 106 may be used interchangeably with the first portion 52 and the second portion 54.

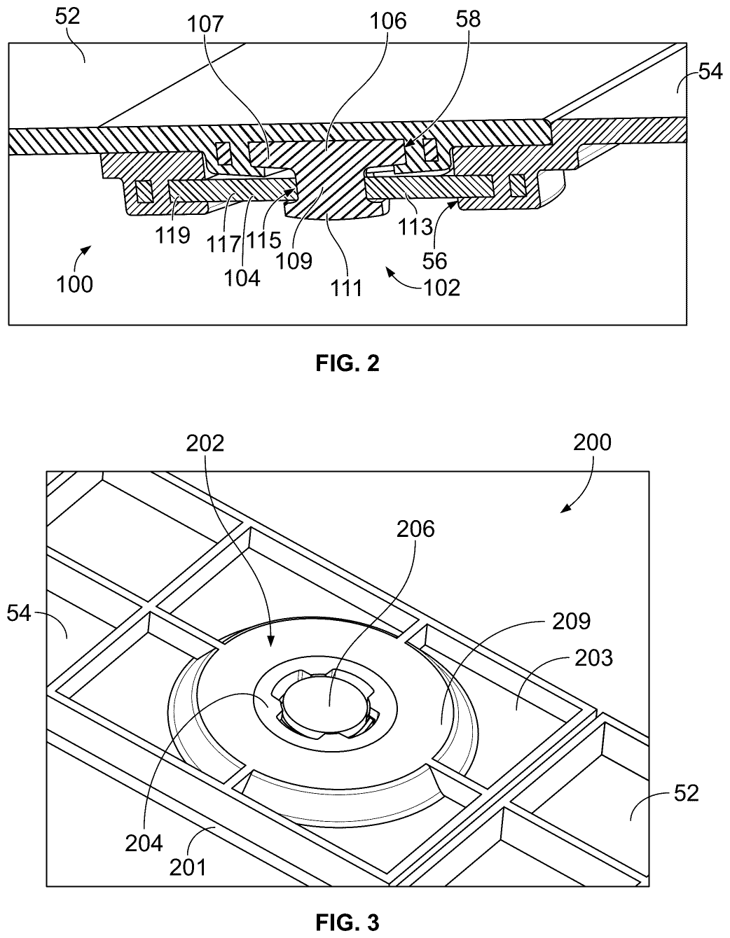

FIG. 2 shows a cross-sectional view of one of the one or more fastener pairs 102 of the fastening system 100. The insertion portion 106 may be disposed within a first fastener orifice 58 in the first portion 52 of the surface covering 50, and the receiving portion 104 may be disposed within a second fastener orifice 56 formed in the second portion 54 of the surface covering. The insertion portion 106 may include a base portion 107, a stem portion 109 protruding from the base portion, and a cap portion 111 extending from the stem portion. In some embodiments, the base portion 107 may have a base diameter that is larger than a stem diameter of the stem portion 109, and the cap portion 111 may have a cap diameter that is larger than the stem diameter. In some embodiments, the insertion portion 106 be a single molded piece, or may be made up of multiple pieces connected to one another in other embodiments. In some embodiments, the base portion 107 of the insertion portion 106 may be removably disposed within the first fastener orifice 58 such that the stem portion 109 may extend away from the first portion 52 of the surface covering 50. Although the illustrated embodiment of the insertion portion 106 shows a separate insert that may be disposed within the first fastener orifice 58 of the first portion 52, it is contemplated that, in some embodiments, the first portion 52 may be moldable to the insertion portion 106 as a single part.

The receiving portion 104 may include a body portion 113 and a receiving orifice 115 formed through the body portion. The body portion 113 may be removably disposed within the second fastener orifice 56 of the receiving portion 104. In some embodiments, the body portion 113 may include multiple arms 117 protruding from an outer portion 119 of the body portion toward the receiving orifice 115 that may be flexible so as to allow insertion into the receiving orifice. In some embodiments, the receiving portion 104 may alternatively be moldable to the second portion 54 of the surface covering 50. In some embodiments, the receiving orifice 115 may have a orifice diameter that is smaller than the cap diameter of the cap portion 111 of the insertion portion 106, but that is substantially equal to or larger than the stem diameter of the stem portion 109. In some embodiments, the cap diameter of the cap portion 111 may be sized such that the cap portion may be forced through the receiving orifice 115 but may resist removal back through the receiving orifice without effort. In other words, the cap portion 111 may be sized so as to be selectively insertable through the receiving orifice 115 and selectively removable, but may resist accidental removal. In some embodiments, the materials making up one or both of the insertion portion 106 and the receiving portion 104 may be substantially pliable or flexible so as to allow for resistive insertion and removal of the insertion portion 106 from the receiving portion 104.

FIG. 3 shows another embodiment of a fastening system 200 that may be used to selectively and removably connect the first portion 52 and the second portion 54 of the surface covering 50. In some embodiments, the first portion 52 may include a first overlapping portion 201 that may be disposed so as to overlap a second overlapping portion 203 of the second portion 54 when the fastening system 200 may be fastening the first portion to the second portion. The fastening system 200 may include one or more fastener pairs 202, which may each include a receiving portion 204 and an insertion portion 206. While only one set of fastener pairs 202 is shown in FIG. 3, it is contemplated that the fastening system 200 may include virtually any number of fastening pairs as appropriate for the particularly application. In some embodiments, the insertion portion 206 may be connected to the first portion 52 of the surface covering 50, and the receiving portion 204 may be connected to the second portion 54 of the surface covering 50. It will be appreciated that, in some embodiments, the insertion portion 206 may be connected to the second portion 54 of the surface covering 50, and the receiving portion 204 may be connected to the first portion 54. It is additionally contemplated that, in some embodiments, each of the receiving portion 204 and/or the insertion portion 206 may be used interchangeably with the first portion 52 and the second portion 54.

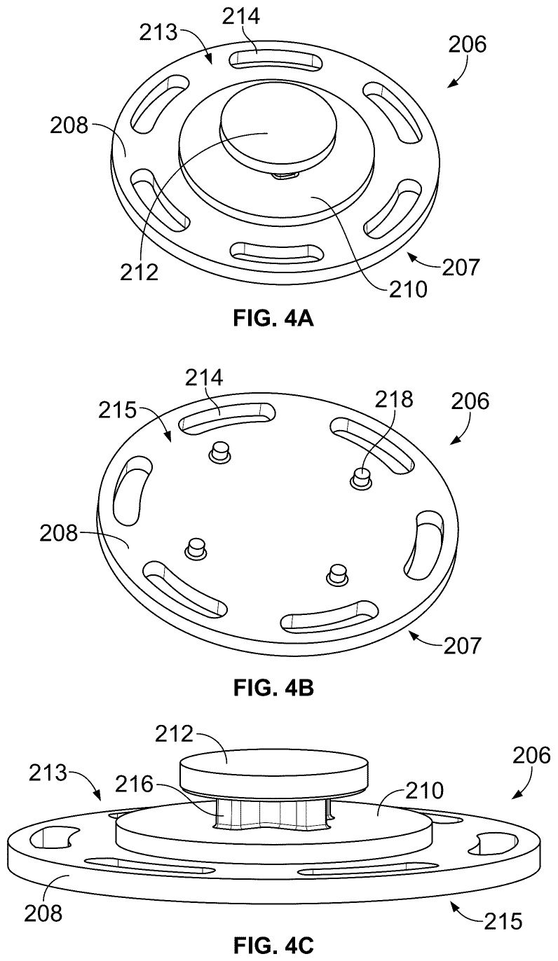

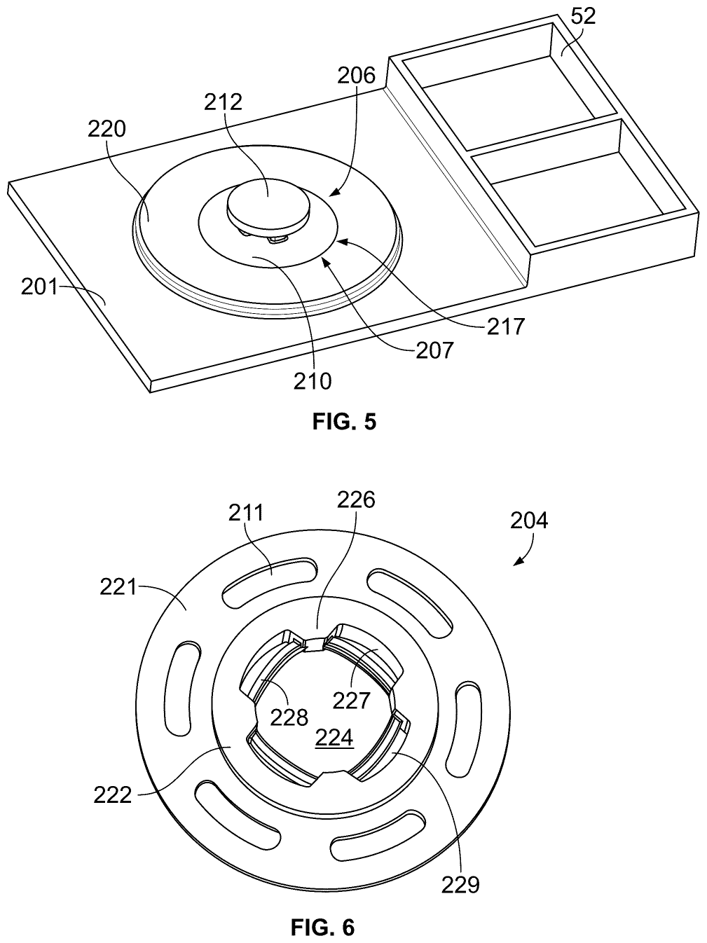

FIGS. 4A, 4B, and 4C each show alternate views of an embodiment of the insertion portion 206 of the fastening system 200. The insertion portion 206 may include a top portion 213 and a bottom portion 215. In some embodiments, the insertion portion 206 may include a base portion 207 including a flange portion 208 and a collar portion 210. The insertion portion 206 may also include a stem portion 216 protruding from the collar portion 210 of the base portion 207, and a cap portion 212 extending from the stem portion. In some embodiments, the flange portion 208 may include one or more flange orifices 214 formed through the flange portion surrounding the collar portion 210. In some embodiments, the base portion 207 may have a base diameter that is larger than a stem diameter of the stem portion 216, and the cap portion 212 may have a cap diameter that is larger than the stem diameter. In some embodiments, the insertion portion 206 may be a single molded piece, or may be made up of multiple pieces connected to one another in other embodiments. The bottom portion 215 of the insertion portion 206 may include one or more protrusions 218 extending from the bottom portion away from the top portion 213. In some embodiments, the protrusions 218 may be spaced substantially equidistant from a center of the base portion 207 and dispersed radially around the base portion.

FIG. 5 shows a partial view of the first portion 52 of the surface covering 50 including the first overlapping portion 201. The first overlapping portion 201 may include a first fastener housing 220 that may house a first fastener cavity 219 that may be accessible through a first fastener housing orifice 217. In some embodiments, the flange portion 208 of the base portion 207 may be removably disposed within the first fastener cavity 219 such that the stem portion 216 and the cap portion 212 may extend through the first fastener housing orifice 217 and protrude away from the first fastener housing 220. In some embodiments, the collar portion 210 of the base portion 207 may have a collar diameter that may be substantially equal to or slightly smaller than a housing orifice diameter of the first fastener housing orifice 217 such that the collar portion may be seated within the first fastener housing orifice.

FIG. 6 shows a top view of the receiving portion 204 of the fastening system 200. In some embodiments, the receiving portion 204 may include a flange portion 221 and a collar portion 222 One or more flange orifices 211 may be formed through the flange portion 221, and may be spaced radially about the collar portion 222. A receiving orifice 224 may be formed axially through the collar portion 222. In some embodiments, one or more arms 226 may protrude radially inward from the collar portion 222 into the receiving orifice 224, and adjacent arms of the one or more arms may be connected by arm rails 228. In some embodiments, the arm rails 228 may be connected to the collar portion 222 or may be spaced away from an inner surface 227 of the collar portion in other embodiments. In some embodiments, an arm rail gap 229 may be formed between each arm rail 228 and the inner surface 227 of the collar portion 222. In some embodiments, each arm rail gap 229 may provide space into which each respective arm rail 228 may flex in response to pressure, such as pressure from the cap portion 212 of the insertion portion being pushed through the receiving orifice 224. In some embodiments, the cap portion 212 may abut the one or more arm rails 228 when disposed within the receiving orifice 224, and the one or more arm rails 228 may be configured to resist movement of the cap portion 212 through the receiving orifice 224

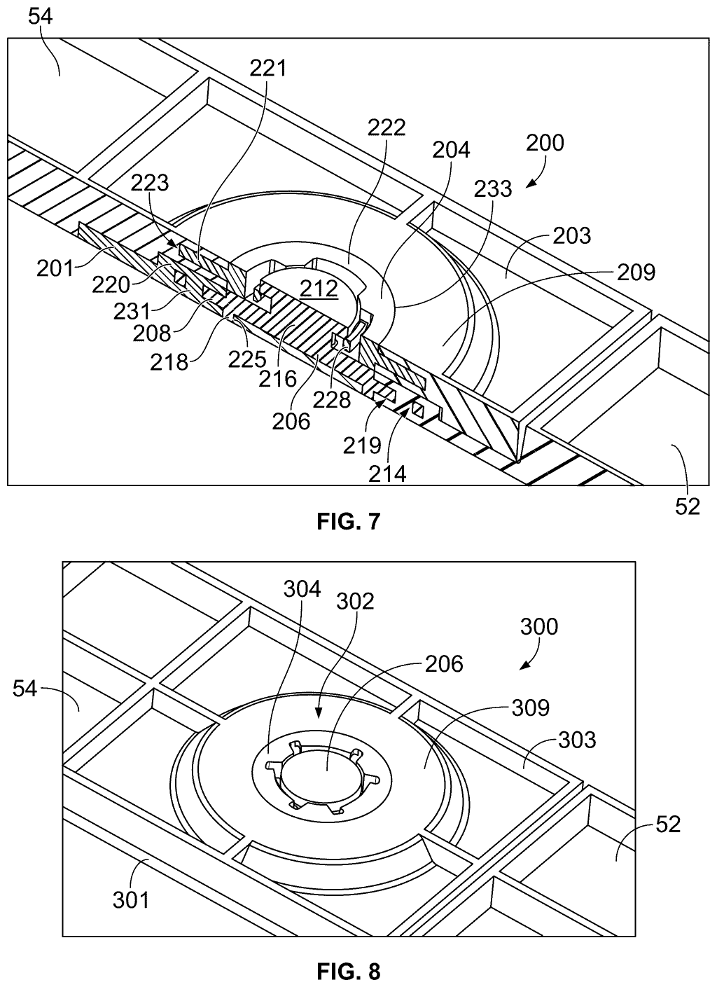

FIG. 7 shows a cross-sectional view of an embodiment of the fastening system 200 in a connected position connecting the first portion 52 and the second portion 54 of the surface covering 50. In some embodiments, the flange portion 208 of the insertion portion 206 may be disposed in the first fastener cavity 219 formed in the fastener housing 220. In some embodiments, the protrusions 218 from the bottom portion 215 of the insertion portion 206 may be disposed in one or more protrusion orifices 225 formed into the first overlapping portion 201 of the first portion 52 of the surface covering 50. In some embodiments, the fastener housing 220 may also include one or more supports 231 that may be disposed through the one or more flange orifices 214 formed through the flange portion 208 that may help hold the insertion portion 206 within the first fastener cavity 219.

In some embodiments, the second overlapping portion 203 may include a second fastener cavity 223 that may be formed in a second fastener housing 209. The flange portion 221 of the receiving portion 204 may be disposed within the second fastener cavity 223, which may seat the receiving portion within the second fastener housing 209. In some embodiments, the collar portion 222 of the receiving portion 204 may have a collar diameter that may be substantially equal to or slightly smaller than a housing orifice diameter of a second fastener housing orifice 233 such that the collar portion may be seated within the second fastener housing orifice. In some embodiments, the stem portion 216 of the insertion portion 206 may be removably disposed within the receiving orifice 224 of the receiving portion 204. The cap portion 212 may extend radially outwardly from the stem portion 216 such that the arm rails 228 may hold the cap portion in place and prevent or resist the cap portion of the insertion portion 206 from pulling out of the receiving orifice 224. Accordingly, the receiving portion 204 may removably receive the insertion portion 206 and hold it in place, removably connecting the first portion 52 and the second portion 54 of the surface covering 50.

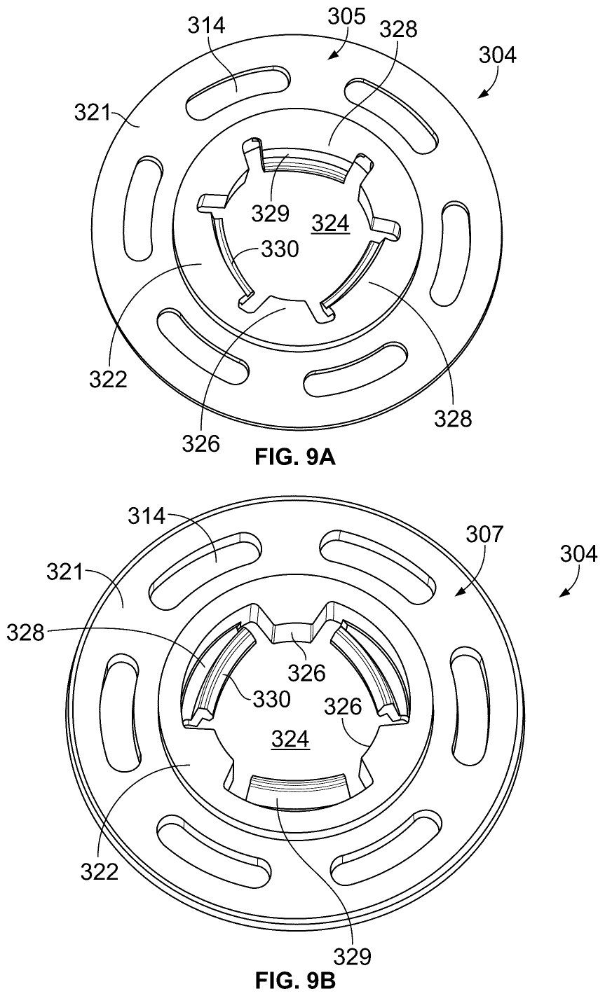

FIG. 8 shows another embodiment of a fastening system 300 that may be used to selectively and removably connect the first portion 52 and the second portion 54 of the surface covering 50. In some embodiments, the first portion 52 may include a first overlapping portion 301 that may be disposed so as to overlap a second overlapping portion 303 of the second portion 54 when the fastening system 300 may be fastening the first portion to the second portion. In some embodiments, the first and/or second overlapping portions 301, 303 may be substantially similar to or identical to the first and/or second overlapping portions 201, 203 shown and described with reference to FIGS. 3-7. The fastening system 300 may include one or more fastener pairs 302 each including of a receiving portion 304 and an insertion portion, which may be the same as or virtually the same as the insertion portion 206 shown and described with reference to FIGS. 3-7. While only one set of fastener pairs 302 is shown in FIG. 8, it is contemplated that the fastening system 300 may include virtually any number of fastening pairs as appropriate for the particularly application. In some embodiments, the insertion portion 206 may be connected to the first portion 52 of the surface covering 50, and the receiving portion 304 may be connected to the second portion 54 of the surface covering 50. It will be appreciated that, in some embodiments, the insertion portion 206 may be connected to the second portion 54 of the surface covering 50, and the receiving portion 304 may be connected to the first portion 54. It is additionally contemplated that, in some embodiments, each of the receiving portion 304 and/or the insertion portion 206 may be used interchangeably with the first portion 52 and the second portion 54.

FIG. 9A shows a top view of a top portion 305 of the receiving portion 304 of the fastening system 300 and FIG. 9B shows a bottom view of a bottom portion 307 of the receiving portion 304. In some embodiments, the receiving portion 304 may include a flange portion 321 and a collar portion 322 One or more flange orifices 314 may be formed through the flange portion 321, and may be spaced radially about the collar portion 322. A receiving orifice 324 may be formed axially through the collar portion 322. In some embodiments, one or more arms 326 may protrude radially inward into the receiving orifice from the collar portion 322. In some embodiments, one or more cantilevered arms 328 may extend inwardly from the collar portion 322 into the receiving orifice 324. The cantilevered arms 328 may each include a vertical portion 329 extending substantially downward into the receiving orifice 324 and a ledge 330 protruding even further inward toward the receiving orifice 324 from each of the vertical portions. In some embodiments, the cantilevered arms 328 may each be disposed between adjacent arms 326 surrounding the receiving orifice. In some embodiments, each vertical portion 329 and the ledge 330 may be configured to flex toward the collar portion 322 in response to, for example, the cap portion 212 of the insertion portion 206. As described in more detail below, once the insertion portion 206 is disposed within the receiving orifice 324, the cap portion 212 may rest against each ledge 330 to resist removal of the insertion portion.

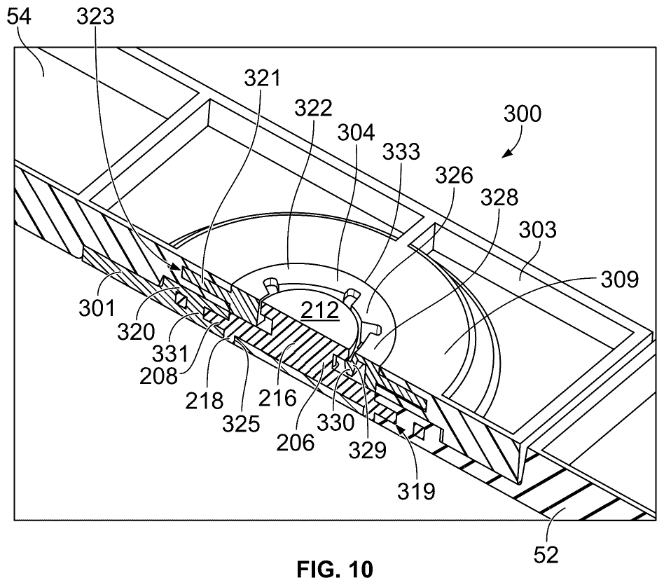

FIG. 10 shows a cross-sectional view of an embodiment of the fastening system 300 in a connected position connecting the first portion 52 and the second portion 54 of the surface covering 50. In some embodiments (such as in FIG. 10), the fastening system 300 may use substantially the same or similar insertion portion 206 as described in reference to the fastening system 200. The flange portion 208 of the insertion portion 206 may be disposed in a first fastener cavity 319 formed in the fastener housing 320. In some embodiments, the protrusions 218 from the bottom portion 215 of the insertion portion 206 may be disposed in one or more protrusion orifices 325 formed into the first overlapping portion 301 of the first portion 52 of the surface covering 50. In some embodiments, the fastener housing 320 may also include one or more supports 331 that may be disposed through the one or more flange orifices 214 formed through the flange portion 208 that may help hold the insertion portion 206 within the first fastener cavity 219.

In some embodiments, the second overlapping portion 303 may include a second fastener cavity 323 that may be formed in a second fastener housing 309. The flange portion 321 of the receiving portion 304 may be disposed within the second fastener cavity 323, which may seat the receiving portion within the second fastener housing 309. In some embodiments, a collar portion 322 of the receiving portion 304 may have a collar diameter that may be substantially equal to or slightly smaller than a housing orifice diameter of a second fastener housing orifice 333 such that the collar portion may be seated within the second fastener housing orifice. In some embodiments, the stem portion 216 of the insertion portion 206 may be removably disposed within the receiving orifice 324 of the receiving portion 304. The cap portion 212 may extend outwardly from the stem portion 216 such that the ledge 330 of the cantilevered arms 328 may abut the cap portion and prevent or resist the cap portion of the insertion portion 206 from pulling out of the receiving orifice 324. Accordingly, the receiving portion 304 may removably receive the insertion portion 206 and hold it in place, removably connecting the first portion 52 and the second portion 54 of the surface covering 50.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A fastening system comprising:
an insertion portion including:
a base portion configured to be coupled to a first portion of a surface covering,
a stem portion protruding axially from the base portion, and
a cap portion protruding radially outward from the stem portion opposite the base portion; and
a receiving portion including:
a collar portion forming a receiving orifice axially through the receiving portion, and
a flange portion extending radially outward from the collar portion and configured to be coupled to a second portion of the surface covering,
wherein the cap portion of the insertion portion is configured to be received through the receiving orifice of the receiving portion such that the stem portion is disposed within the receiving orifice, thereby fastening the insertion portion to the receiving portion and removably connecting the first portion of the surface covering to the second portion of the surface covering.

2. The fastening system of claim 1, wherein a cap diameter of the cap portion and a base diameter of the base portion are both larger than a stem diameter of the stem portion, and wherein the cap portion of the insertion portion is configured to abut the collar portion of the receiving portion such that the collar portion resists movement of the cap portion through the receiving orifice.

3. A fastening system for fastening a first portion of a surface covering to a second portion of the surface covering, the fastening system comprising:
an insertion portion including a base portion and a cap portion protruding from the base portion, the base portion configured to be disposed within a first fastener cavity of the first portion of the surface covering; and
a receiving portion including a flange portion and a collar portion forming a receiving orifice axially through the receiving portion, the flange portion extending radially outward from the collar portion and configured to be disposed within a second fastener cavity of the second portion of the surface covering;
wherein the cap portion of the insertion portion is configured to be received through the receiving orifice of the receiving portion so as to fasten the insertion portion to the receiving portion.

4. The fastening system of claim 3, wherein the base portion of the insertion portion further comprises a flange portion and a stem portion, the flange portion extending radially outward and the stem portion extending axially away from the flange portion, and where in the cap portion is disposed on the stem portion opposite the flange portion.

5. The fastening system of claim 4, wherein the flange portion of the base portion is configured to be disposed within the first fastener cavity of the first portion of the surface covering and wherein the stem portion of the base portion is configured to be disposed within the receiving orifice of the receiving portion.

6. The fastening system of claim 4, wherein a cap diameter of the cap portion is larger than a stem diameter of the stem portion.

7. The fastening system of claim 4, wherein a base diameter of the base portion at the flange portion is larger than the stem diameter.

8. The fastening system of claim 5, wherein the collar portion of the receiving portion further comprises one or more arms protruding radially inward from the collar portion into the receiving orifice.

9. The fastening system of claim 8 further comprising one or more arm rails connecting each adjacent pair of arms of the one or more arms, wherein one or more arm rails are configured to resist movement of the cap portion through the receiving orifice.

10. The fastening system of claim 8 further comprising one or more cantilevered arms protruding radially inward from the collar portion into the receiving orifice, wherein each of the one or more cantilevered arms is disposed between each adjacent pair of arms of the one or more arms, wherein each of the one or more cantilevered arms is configured to flex toward the collar portion in response to the cap portion being inserted into the receiving orifice.

11. The fastening system of claim 10, wherein each of the one or more cantilevered arms includes a ledge configured to abut the cap portion so as to resist movement of the cap portion through the receiving orifice.

12. A surface covering comprising:
a first portion including a first fastener housing;
a second portion including a second fastener housing;
an insertion portion including a base portion and a cap portion protruding from the base portion, the base portion disposed within the first fastener housing of the first portion; and
a receiving portion including a flange portion and a collar portion forming a receiving orifice, the flange portion disposed within the second fastener housing of the second portion;
wherein the cap portion of the insertion portion is configured to be removably received through the receiving orifice of the receiving portion so as to fasten the first portion to the second portion.

13. The surface covering of claim 12, wherein the base portion of the insertion portion further comprises a flange portion and a stem portion, the flange portion extending radially outward and the stem portion extending axially away from the flange portion, and where in the cap portion is disposed on the stem portion opposite the flange portion.

14. The fastening system of claim 13, wherein the flange portion of the base portion is configured to be disposed within the first fastener housing of the first portion of the surface covering and wherein the stem portion of the base portion is configured to be disposed within the receiving orifice of the receiving portion.

15. The fastening system of claim 13, wherein a cap diameter of the cap portion is larger than a stem diameter of the stem portion.

16. The fastening system of claim 15, wherein a base diameter of the base portion at the flange portion is larger than the stem diameter.

17. The fastening system of claim 12, wherein the collar portion of the receiving portion further comprises one or more arms protruding radially inward from the collar portion into the receiving orifice.

18. The fastening system of claim 17 further comprising one or more arm rails connecting each adjacent pair of arms of the one or more arms, wherein one or more arm rails are configured to resist movement of the cap portion through the receiving orifice.

19. The fastening system of claim 17 further comprising one or more cantilevered arms protruding radially inward from the collar portion into the receiving orifice, wherein each of the one or more cantilevered arms is disposed between each adjacent pair of arms of the one or more arms, wherein each of the one or more cantilevered arms is configured to flex toward the collar portion in response to the cap portion being inserted into the receiving orifice.

20. The fastening system of claim 19, wherein each of the one or more cantilevered arms includes a ledge configured to abut the cap portion so as to resist movement of the cap portion through the receiving orifice.
